(19) United States
(12) Patent Application Publication
(10) Pub. No.: US 2026/0326510 A1
(43) Pub. Date: Oct. 22, 2026

(54) DRIVE FOR A VEHICLE EQUIPMENT DEVICE, EQUIPMENT DEVICE, AND METHOD FOR DRIVING AN ACTUATOR COMPONENT OF AN EQUIPMENT DEVICE

(71) Applicants: GRAMMER AG, Ursensollen (DE); GRUNER AG, Wehingen (DE)

(72) Inventor: Marco KAUSCHWITZ, Brigachtal (DE)

(21) Appl. No.: 19/647,266

(22) Filed: Apr. 14, 2026

(30) Foreign Application Priority Data
Apr. 17, 2025 (DE) 10 2025 115 330.2

(51) Int. Cl. B60H 1/34

(52) U.S. Cl. CPC B60H 1/3414; B60H 2001/3471

(57) ABSTRACT

A drive for an adjustment component of an equipment device for a vehicle with a drive shaft which is rotatable about an axis of rotation in different directions and is designed for connection to an adjusting element of the vehicle equipment part. The drive has a first magnet, which is an electromagnet and is polarity-reversible, and is fixedly arranged relative to a base. A second magnet is arranged rotatably within range of the magnetic field of the first magnet in opposite directions of rotation, and the angle of rotation thereof is limited by a limiter. The second magnet is rotationally connected to the drive shaft and the first magnet is connected to a control device for controlling the current supply and the polarity of the first magnet.

According to a first aspect of the invention, the invention relates to a drive for a vehicle equipment part. In the sense of the invention, a vehicle is, for example, a land, air, or water vehicle.

Such a drive is known from prior public use. It comprises at least one drive motor with a drive axis, which is connected via a transmission to an adjusting device of the equipment part. By means of position-determining means, such as a Hall sensor or potentiometer, the current position of movable parts of the equipment part could be determined.

From DE 10 2019 121 738 A1, an operating device for a pivotably mounted air guide element is known, which can be adjusted via an actuator and manually. The air guide element is part of an air outlet which has an operating device with an operating element. The operating element interacts with an adjusting element that is coupled to the air guide element. The adjusting element can be moved by means of an actuator, which can be formed by an electric motor, a stepper motor, a linear drive and/or a magnetic drive.

DE 10 2017 130 404 A1 describes a hybrid actuation system for the nozzle outlet throttle flap of a vehicle. Hybrid actuation here means that the throttle flap can be adjusted both manually and by means of a drive.

EP 1 048 499 A1 describes a fan flap of a motor vehicle which can be adjusted manually by means of a hand lever. The fan flap can additionally be adjusted by means of a motorized drive. A position detection is provided in order to determine the respective position of the fan flap.

DE 10 2005 061 349 A1 relates to an adjusting device for adjusting louvers of an air nozzle in a motor vehicle. The adjusting device permits manual as well as controlled adjustment of the louvers. Manual actuation takes place at an adjusting wheel coupled to the louvers. Controlled adjustment of the louvers is possible with an actuator comprising a motor, which is likewise coupled to the adjusting wheel. The motor comprises a rotor, which is connected to the adjusting wheel and is designed as an outer rotor. A stepper motor is proposed as the motor.

The invention according to DE 30 34 558 A1 relates to a wind direction control for a ventilation system. A first pair of wind-deflecting plates can be controlled manually. A second pair is connected to a drive device, which causes a periodic change in the wind direction.

DE 10 2019 102 826 A1 discloses a device for manipulating an actuating member in the form of a throttle or closure flap of an air outlet. For manipulating an actuating member, a manually operable actuating element as well as a motorized drive are provided. A return device moves the actuating member back to its starting position after actuation.

It was the object of the invention to create a drive for an equipment part which has a low space requirement and causes little noise. It was also an object of the invention to create a drive that can be driven both electrically and manually. The electric drive should be such that the movement of the movable parts is uniform. During manual actuation, the movable part should be movable in a haptic advantageous manner without noticeable influence by the drive. In addition, the drive should have few components.

The object was achieved by a drive having the features of claim 1.

The drive for a vehicle equipment part comprises a drive shaft, which is rotatable about an axis of rotation in different directions in order to move at least one movable part of the equipment device. The drive shaft is designed for connection to a drive element of the vehicle equipment part. A drive unit comprises a first magnet, which is fixedly arranged relative to a base. The first magnet is designed as an electromagnet.

A second magnet is rotatably arranged within range of the magnetic field of the first magnet. The angle of rotation of the second magnet is limited by limiting means. The second magnet is fixedly connected to the drive shaft or formed integrally therewith.

A current supply of the first magnet is connected to a control device for controlling the current supply to the first magnet. In this way, the magnet can be switched on, switched off, and polarity-reversed. During manual actuation of the equipment device, the first magnet is switched de-energized by the control. If the equipment device is to be moved by means of the drive, the control device controls the current supply and the polarity of the first magnet as a function of the target value of the position of the at least one movable part.

The current supply can be switched on and off. The polarity can be changed in such a way that the north pole and the south pole of the first magnet are exchanged. The control controls the first magnet as a function of the actual position and the target position. If the current supply is switched on, the magnetic field of the first magnet, depending on the polarity, exerts a torque on the second magnet, so that it rotates with the drive axis into the desired target position. If the target position is reached, the first magnet is switched de-energized.

The advantage of the invention consists, among other things, in the fact that by means of the drive according to the invention, at least one movable part of an equipment device can be driven both electrically and manually. In addition, the drive requires little installation space. The manual and motorized actuation of the movable part causes little noise. The drive according to the invention requires few parts and causes low assembly effort. When a damping device is used, the movement of the movable parts is uniform, so that the drive leaves a tactically advantageous impression during manual actuation. During manual actuation, the drive does not noticeably influence the movement. In other words, an influence of the drive on the movement cannot be detected by the person carrying out the actuation. In addition, for example, the damping of the rotational movement of the second magnet permits improved and more precise control in interaction with a position detection. The drive according to the invention also has short adjustment times.

The movement of the second magnet is damped by a damping device. By means of the damping device, torsional vibrations can be avoided and thus the service life of the second magnet can be increased. The damping device levels out a stick-slip effect during the transition from static friction to sliding friction. As a result, the user does not perceive this effect during manual actuation of the adjustment component.

For example, the damping device is formed by a fluid damper. The damping takes place, for example, in that the second magnet or components connected thereto, such as, for example, the drive axis, moves in a viscous liquid. Thus, no abrupt or impact-like movements occur. The viscous fluid is formed, for example, between the second magnet and the wall of a receptacle or, for example, between the drive axis and the corresponding bearing location in the housing.

As an alternative or in addition to the fluid damper, other damping devices, such as, for example, magnetic damping or friction damping, may also be considered.

The second magnet is, for example, a permanent magnet. The material can be formed, for example, by a sintered magnet or by a thermoplastic provided with magnetic additives. By means of sintered magnets, high magnetic forces can be generated, so that large torques act in the drive shaft. The permanent magnet is a diametrically magnetized magnet. Only two poles lie opposite one another.

The drive shaft is, for example, connected to an adjusting element of an adjustment component of the equipment device in order to move the at least one movable part of the adjustment component. Components moved simultaneously thereto can be operatively connected by further coupling elements to the adjusting element, the adjustment component, or the drive shaft. A direct connection is also possible.

The position of the drive shaft can be determined by means of position detection means. Such position detection means are customary. Suitable means can be selected.

For example, the position detection means comprise a Hall sensor or a potentiometer or optical detection markings or feelers.

The position detection means comprise, for example, the second magnet, in particular a permanent magnet, as a position-providing component. No additional components are then necessary which interact with the sensor, such as, for example, a Hall sensor.

The angle of rotation of the second magnet is limited by means of an angle-of-rotation limiter, for example, to α≤180°, in particular α≤120°, in particular 80°≤α≤100°. The angle-of-rotation limiter can comprise, for example, stops of the second magnet and counter-stops of the drive housing or of the drive shaft rotationally integral with the second magnet and the housing of the equipment device, which can come into angle-limiting contact. No uncontrolled movements of the second magnet then occur. If the vehicle equipment part is, for example, an air outlet, and the adjustment component is a louver arrangement whose louvers, i.e. horizontal and/or vertical louvers, are driven by the drive according to the invention, adjustability of the louvers in this angular range is possible.

The first magnet and the second magnet are, for example, mounted on or at a plate and/or at least partially in a housing, wherein the plate or the housing forms the base.

In the de-energized state of the first magnet, the second magnet is subject to the holding torque of the damping device. This makes manual operation of the equipment part possible without a resistance from the first magnet impairing the movement of the movable part. If, for example, the vehicle equipment part is an air outlet, the louvers can, for example, be moved via the damping resistance of the damping device. In addition, in the de-energized state, the damping device holds the at least one movable part of the adjustment component in the set position.

The second magnet is, for example, designed as a plate or disc. That is to say that its thickness is small in relation to its longitudinal and transverse extension. The second magnet then requires little installation space parallel to the extent of its thickness. The overall dimensions of the drive can therefore be kept small.

An operating device is, for example, designed with first operating means for manual actuation and has second operating means, which interact with the control device in order to actuate the adjustment component by means of the drive. The first operating means can be formed, for example, by an actuating attachment such as an operating handle, operating wheel, lever or the like. The second operating means are, for example, a touch display, pushbuttons, a rotary or sliding controller, or other input means that interact with the control device. Further input means are likewise conceivable, such as optical detection systems, for example gesture recognition, or acoustic detection systems, for example voice recognition.

The second magnet is designed relative to the magnetic core, for example, as an inner rotor, disc rotor, or as an outer rotor. Depending on the operating conditions, a suitable variant can be selected.

The second magnet is, for example, diametrically magnetized. A plane between north pole and south pole divides, for example, a magnet designed as a disc centrally. When a circular disc is used, for example, 180° of the disc are magnetized as the north pole and a further 180° as the south pole.

According to a second aspect, the invention also relates to an equipment part having at least one drive corresponding to the first aspect of the invention. The equipment part is, for example, an equipment part of a vehicle. For example, the louvers, i.e. for example vertical louvers and horizontal louvers and/or closure flaps for closing the air flow of at least one line of an air outlet, can be actuated by means of the drive according to the invention.

According to a third aspect, the invention relates to a method for driving an adjustment component of an equipment device (10) for a vehicle.

Such a method is known from the prior art mentioned in relation to the first aspect.

The method uses a drive with a drive shaft which is rotatable about an axis of rotation in different directions and is designed for connection to an adjusting element of the equipment device. The method comprises the following method steps:

A first magnet, which is designed as an electromagnet, is provided. The electromagnet can be driven in opposite directions of rotation and can be switched de-energized. A second magnet is arranged within range of the magnetic field of the first magnet, wherein the second magnet is mounted rotatably in opposite directions of rotation and wherein its angle of rotation is limited by limiting means.

The second magnet is rotationally connected to the drive shaft.

The first magnet is connected to a control device for controlling the current supply and the polarity of the first magnet, so that the first magnet is polarity-reversible when current is supplied and can be switched de-energized.

The current supply can be switched on and off by means of the control. The polarity can be changed in such a way that the north pole and the south pole of the first magnet are exchanged. The control controls the first magnet as a function of the actual position and the target position. If the current supply is switched on, the magnetic field of the first magnet, depending on the polarity, exerts a torque on the second magnet, so that it rotates with the drive axis into the desired target position. If the target position is reached, the first magnet is switched de-energized.

The advantage of the method consists, among other things, in the fact that an adjustment component of an equipment device can be driven both electrically and manually. Driving the adjustment component with the method requires little installation space. The manual and motorized actuation of the movable part causes little noise. The assembly effort is low. When a damping device is used, the movement of the movable parts is uniform, so that the drive leaves a tactically advantageous impression during manual actuation. During manual actuation of the adjustment component, the drive does not noticeably influence the movement. In other words, an influence of the drive on the movement cannot be detected by the person carrying out the actuation. In addition, for example, damping of the rotational movement of the second magnet permits improved and more precise control in interaction with a position detection.

Embodiments of the invention are described by way of example in the following description of the figures, also with reference to the drawings. For the sake of clarity, the same or comparable parts or elements or regions are designated with the same reference signs, in some cases with the addition of lower-case letters, even where different embodiments are concerned.

Features which are described only in relation to one embodiment can, within the scope of the invention, also be provided in any other embodiment of the invention.

All disclosed features are essential to the invention in themselves.

The Figures show in:

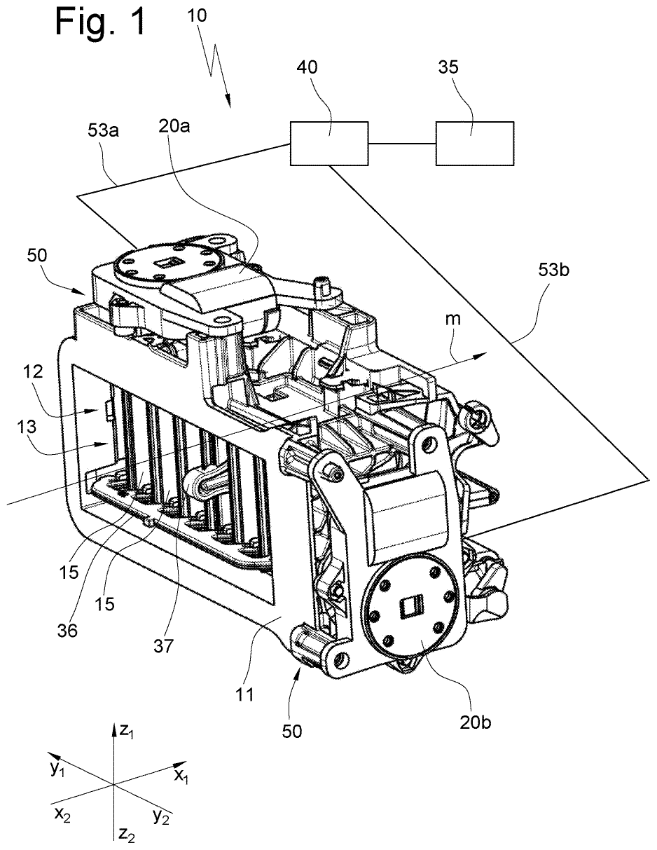

FIG. 1 a perspective view of an air outlet of a vehicle, comprising two of the drives according to the invention,

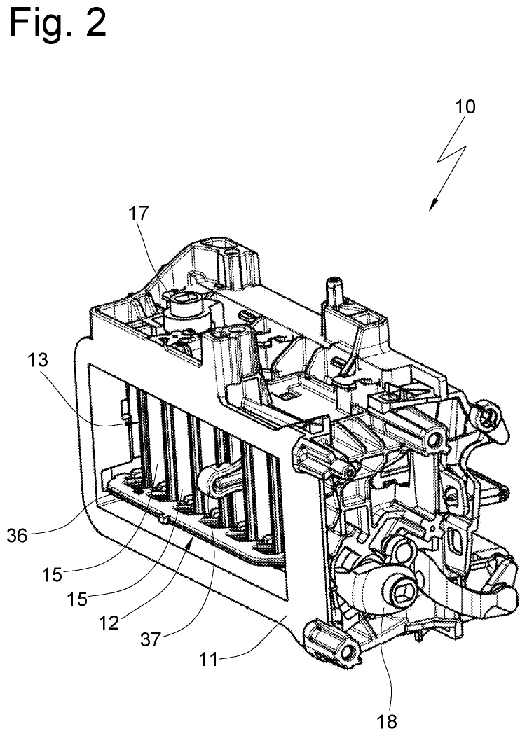

FIG. 2 the air outlet according to FIG. 1, wherein the drives are not shown for the sake of clarity,

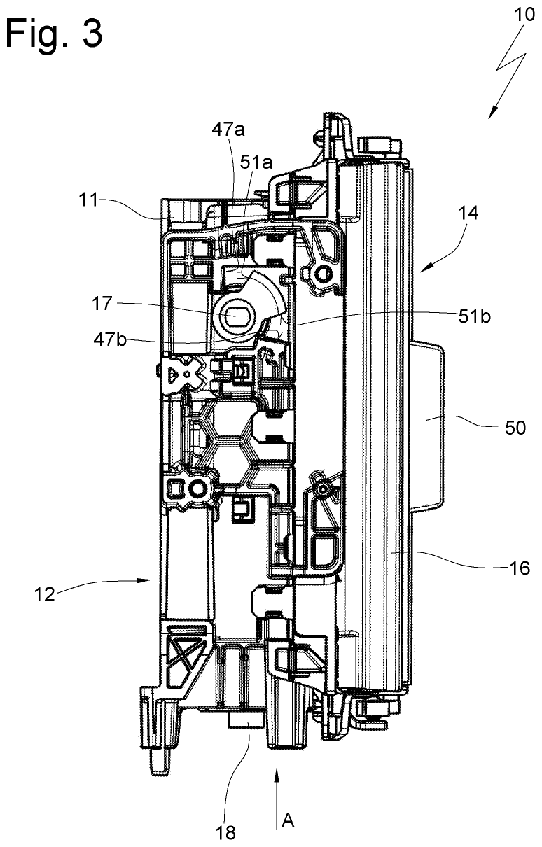

FIG. 3 a top view of the air outlet according to FIG. 2,

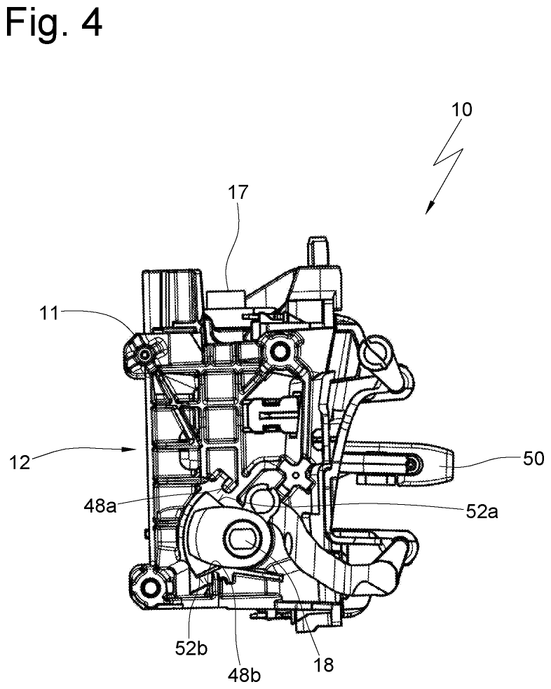

FIG. 4 a view according to viewing arrow A in FIG. 3,

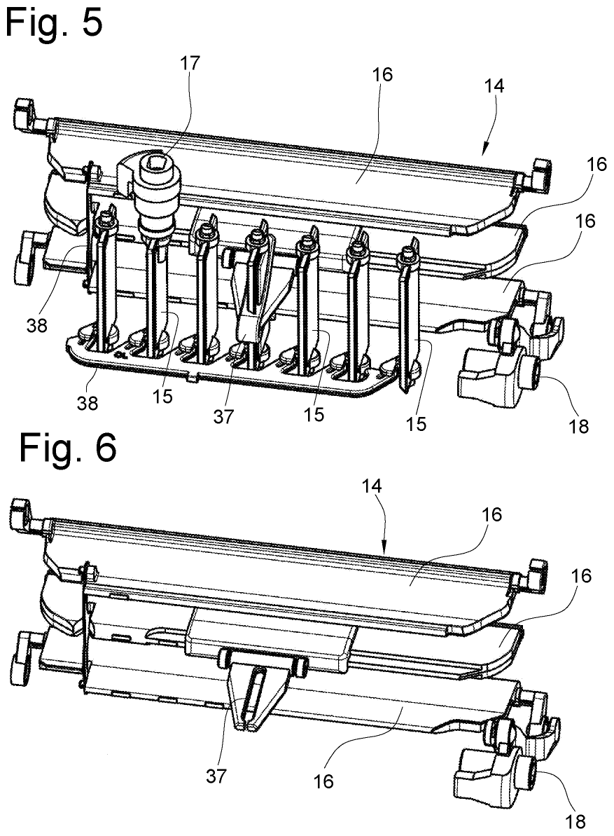

FIG. 5 a view of the first louvers as well as the second louvers as well as the first adjusting element and the second adjusting element,

FIG. 6 a view of the horizontal louvers,

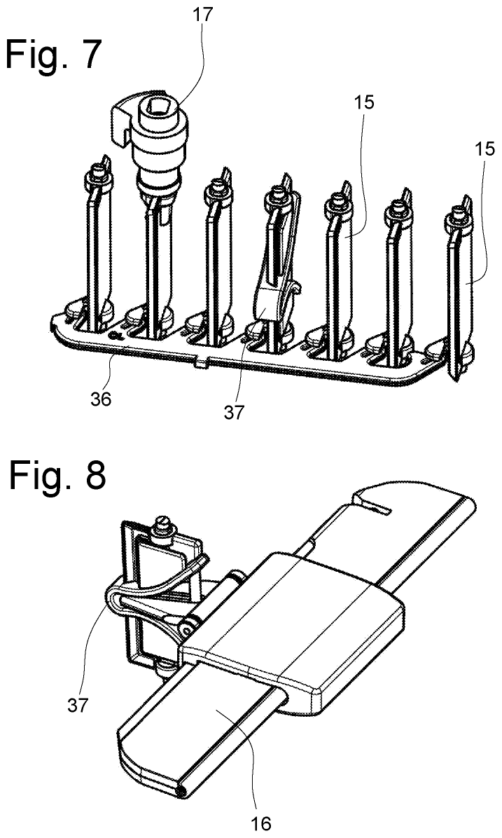

FIG. 7 a view of the vertical louvers,

FIG. 8 a view of a horizontal louver with connector

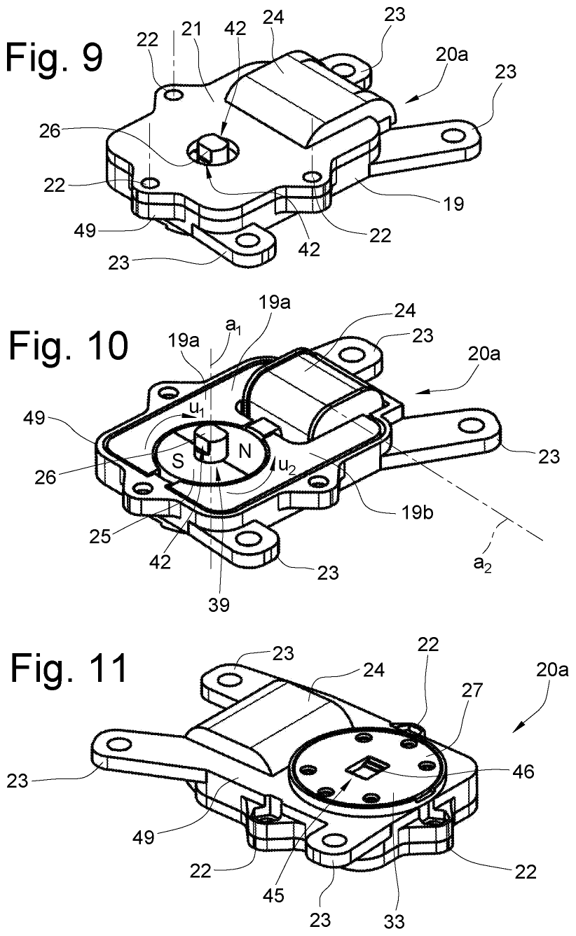

FIG. 9 a perspective view of a drive of the air outlet,

FIG. 10 a view based on FIG. 9, wherein the cover of a housing of the drive is not shown,

FIG. 11 a bottom view of the drive according to FIG. 9,

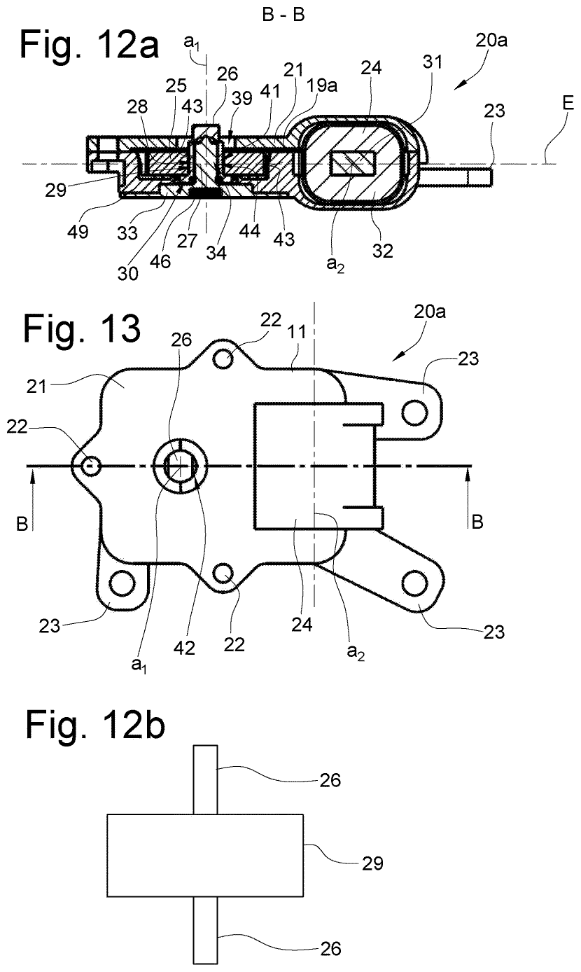

FIG. 12a a sectional view according to section line B-B in FIG. 13,

FIG. 12b an alternative embodiment of the damping device,

FIG. 13 a top view of the drive according to FIG. 9,

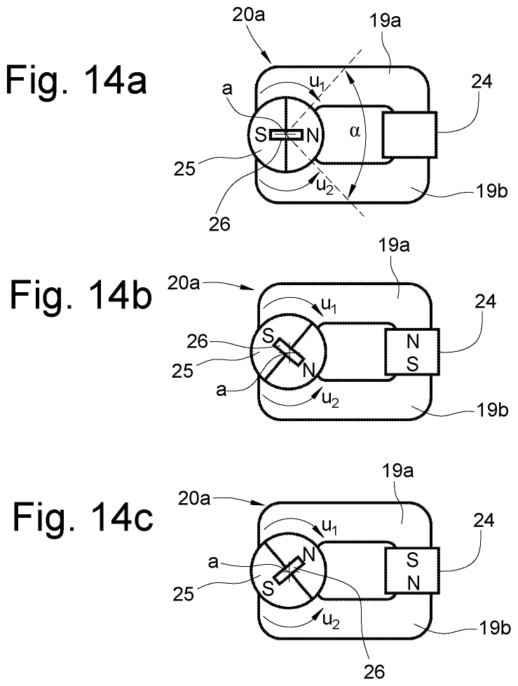

FIG. 14a a schematic view of the drive, wherein the first magnet is switched de-energized,

FIG. 14b a schematic view of the drive, wherein the first magnet is polarized in a first manner,

FIG. 14c a schematic view of the drive, wherein the first magnet is polarized in reverse with respect to FIG. 14b.

In FIG. 1, an equipment device 10 in the form of an air outlet for a vehicle is shown. The air outlet comprises a housing 11 with an air inlet opening 12 through which an air flow can enter the air outlet. An air-flow direction is designated by m. By means of a first vertical louver unit 13, the air flow can be deflected in direction y1 and y2, and by means of a second horizontal louver unit 14 (not visible in FIG. 1), the air flow can be deflected in direction z1 and z2. The louver units 13 and 14 each form an adjustment component of the equipment device 10. The directions x1, x2, y1, y2 and z1, z2 correspond to a customary coordinate system.

The first louver unit 13 comprises vertical louvers 15 and the second louver unit 14 comprises horizontal louvers 16. The term “vertical” means that a central axis of the louvers 15 is oriented approximately parallel to a z-axis. The term “horizontal” means that a central axis of the louvers 16 is oriented approximately parallel to a y-axis. The directions x1 and x2 are directed parallel to the axis m of the equipment device 10.

The movement of the louver units 13 and 14 can be carried out by means of an actuating device, wherein the actuation can take place manually by means of an operating device, for example with the operating lever 37, or by means of the adjusting device 50 by way of drives 20a and 20b. By means of the adjusting device 50, the louver units 13 and 14 can be moved in the desired manner by means of one drive 20a and 20b in each case.

The drives 20a and 20b are controlled by a control device 40. The drives 20a and 20b are each connected to the control device 40 by a line 53a and 53b. The user input takes place by means of a user interface 35, with which the desired values can be set and transmitted to the control device 40. The user interface 35 may, for example, comprise a touch display, a sliding switch, or a rotary switch for setting the air outlet 10. The control device 40 and the operating device 35 are shown only schematically. The control device 40 controls the energization and polarity of the first magnet 24 as a function of the actual position and the target position of the second magnet 25.)

The drives 20a and 20b comprise a drive shaft 26 (not visible in FIG. 1), which in each case interacts with an adjusting element. In FIG. 2, the adjusting element 17 can be seen, which is moved by the drive 20a, as well as the adjusting element 18, which is moved by the drive 20b. The adjusting elements have recesses which are formed complementarily to the form-fit structure 42 of the drive shaft 26, so that the drive shaft 26 is in form-fitting engagement with the respective adjusting element 17 and 18, respectively.

The louvers 15 of the vertical louver unit 13 as well as the louvers 16 of the horizontal louver unit 14 are connected to one another by connectors, so that they move synchronously. The horizontal louvers 16 are connected to one another by a connector 38. The louvers 15 as well as the louvers 16 are pivotably mounted on the housing 11.

In FIGS. 9 to 13, the drive 20a is shown by way of example. The drives 20a and 20b have an identical construction. Therefore, only drive 20a will be explained here. The drive 20a comprises a housing, comprising a base part 49 as well as a cover 21. In FIG. 9, an electromagnet 24 in the form of a coil can furthermore be seen, which is fixedly connected to the drive housing, for example to the base part 49, and which can be polarized differently or switched de-energized by means of the control 40.

Furthermore, the drive shaft 26 can be seen in FIG. 9, which is rotatable about the axis of rotation a1 in directions u1 and u2, but whose angle of rotation a is limited. The cover 21 is fastened to the base part 49 here by way of example with screw connections 22, which are shown only schematically by means of a dash-dotted line. Alternatively, any other suitable fastening, such as, for example, a clip connection or welded connection, may be used. The base part 49 furthermore has flanges 23 for fastening to the housing 11.

In FIG. 10, the drive 20a is shown without the cover 21. It can be seen that a second magnet 25, which is designed as a permanent magnet, is rotatably mounted in the effective region of the magnetic field of the first magnet 24. The north pole of the second magnet 25 is marked with “N” and the south pole with “S”. The second magnet 25 is, for example, shaped as a disc, in the present example as a circular disc, which is received in a recess 41 of the base part 49, but it could alternatively also be designed differently, for example as a bar magnet. The second magnet 25 has a diametrical magnetization.

In this example, the drive shaft 26 is designed as a separate plastic part, which passes through a recess 39 in the second magnet 25. It is connected to the second magnet 25 in a rotationally fixed manner. For connection to the respective adjusting element, the drive shaft 26 has a form-fit structure 42, which in this example is formed by opposite parallel flats, but which may alternatively also be configured differently.

A metal core 31, not completely visible in FIG. 10, continues with plate cores 19a and 19b in order to conduct the magnetic field of the first magnet 24 to the second magnet 25. The plate cores 19a and 19b, also called pole shoes, are designed in this example as a thin plate whose surface extent is large in relation to its thickness. In this way, a small installation space can be ensured. The plate cores 19a and 19b surround the second magnet 25 designed as a disc. The plate cores 19a and 19b lie in plane E.

FIG. 11 shows an underside of the drive 20a. A disc 33 is received in the base part 49, which forms part of a bearing seat 27 for the second magnet 25. In principle, the bearing seat, as in this example, may be a separate part or alternatively may, for example, be integrally formed on the drive housing, for example on the base part 49. A sensor 46 is furthermore received in the bearing seat 27, which is part of a position detection 45 for the second magnet 25. The electrical connection for the sensor is not shown for the sake of clarity. The second magnet 25 is the position-providing component for the sensor 46. That is to say, apart from the sensor 46, no further parts are required on the second magnet 25 for position detection.

As shown in FIG. 12, the second magnet 25 designed as a disc is arranged in a plane E which intersects the first magnet 24, in particular the magnetic core 31 of the electromagnet. A central axis a2 of the magnetic core 31 of the first magnet 24 is arranged approximately at a right angle to an axis of rotation a1 of the second magnet 25. The axis of rotation a1 stands approximately perpendicular to the plane E. The geometric axis of rotation a1 does not intersect the first magnet 24. The axes a1 and a2 are skew. With this arrangement, the installation space of the drives 20a and 20b can be minimized.

FIG. 12 shows a sectional view through the drive 20a. The bearing seat 27 has a pin 34, which is fixedly connected to the disc 33 and passes through the recess 39 of the second magnet 25. The pin 34 serves as a rotary bearing for the movement unit consisting of the second magnet 25 and the drive shaft 26. Alternatively, the pin 34 could also, for example, be integrally formed on the drive housing.

A damping device 30 comprises a fluid damper 29, which is accommodated in a radial gap 28 between an outer surface 43 of the pin 34 and an inner surface 44 of the hollow drive shaft 26. By means of the fluid damper 29, the movement of the second magnet 25 is made more uniform, so that jerky movements are prevented. In addition, the fluid damper 29 exerts a holding torque on the second magnet 25 in the de-energized state of the first magnet 24.

In this example, the fluid damper 29 has a paste-like consistency, which can be arranged with or without encapsulation, for example in the gap 28. Space is thereby saved. According to an alternative embodiment, at least one other gap between the second magnet 25 and the recess 41 would also be conceivable for receiving the fluid damper 29. Alternatively, for example, an extension of the drive shaft 26 could also be connected to a device designed like a conventional rotational brake. In the sectional view according to FIG. 12, the metal core 31 as well as a coil 32 of the first magnet 24 can be seen.

In FIG. 13, the drive shaft 26 with the form-fit structure 42 can be seen.

The function is described with reference to FIGS. 14a to 14c. According to FIG. 14a, the first magnet 24 is de-energized and has no polarity. The position according to FIG. 14a was selected arbitrarily. In the de-energized state of the first magnet 24, the second magnet 25 can stand in any position between the mechanical stops. In this case, for the drive 20a these are the stops 47a and 47b (see FIG. 3), which interact with counter-stops 51a and 51b, and for the drive 20b the stops 48a and 48b (see FIG. 4), which interact with counter-stops 52a and 52b. Alternatively, the stops could, for example, also be formed on the second magnet 25 and the housing 11.

The second magnet 25 with the drive shaft 26 can therefore be moved in the de-energized state of the first magnet 24 within the limits of mechanical stops. In this example, the stops are designed such that, starting from a central position shown in FIG. 14a, the second magnet can be pivoted by approximately +/−45° in directions u1 and u2. In this example, this also corresponds, for example, to the pivot angle of the louvers 15 and the louvers 16. Thus, when the vertical louver unit 13 or the horizontal louver unit 14 is moved manually, the second magnet 25 moves correspondingly with it.

During the manual movement of the louver units 13 and 14, the fluid damper 29 provides an advantageous tactile feel.

According to FIG. 14b, the first magnet 24 is polarized in a first manner. The north pole of the first magnet 24 is also designated by “N” and the south pole by “S”. The north pole of the second magnet 25 is attracted by the south pole of the first magnet 24, so that the second magnet 25 rotates from the position according to FIG. 14a in direction u1. According to FIG. 14b, the second magnet is shown in its first end position, which is defined by the contact of the stops. With reversed polarity of the first magnet according to FIG. 14c, the second magnet 25 moves, for example, from the position according to FIG. 14b in direction u2 into the second end position according to FIG. 14c.

Intermediate positions between the first end position and the second end position can be set by de-energizing the first magnet 24 when the desired target position is reached. The polarity of the first magnet 24 and the energization of the first magnet 24 are set by the control device 40 as a function of the set target value and the actual value of the position of the drive shaft 26 or of the rotationally integral second magnet 25 determined by the sensor 46. In order to pivot the drive shaft 26 from the determined actual position in direction u1, the first magnet is polarized correspondingly to FIG. 14b, and in order to pivot in direction u2, it is polarized correspondingly to FIG. 14c.

It becomes clear that, with the drive according to the invention, the adjustment of an adjustment component of an equipment part 10 is possible with little space requirement, wherein both a manual actuation and an actuation of a movable part of the adjustment component by means of the drive can take place.

1-15. (canceled)

16. A drive for an adjustment component of an equipment device for a vehicle having a drive shaft rotatable about an axis of rotation in different directions and configured for connection to an adjusting element of the equipment device, the drive comprising: a base; a first magnet configured as an electromagnet and being polarity-reversible and fixedly arranged relative to the base; a second magnet arranged rotatably within range of a magnetic field of the first magnet in opposite directions of rotation, and and angle of rotation of the second magnet being limited by a limiter, wherein the second magnet is rotationally connected to the drive shaft; and wherein the first magnet is connected to a control device for controlling the current supply to the first magnet and the polarity of the first magnet so that polarity of the first magnet is reversed when current is supplied and the first magnet is switched into a de-energized state.

17. The drive according to claim 16, further comprising a damping device configured to damp movement of the second magnet.

18. The drive according to claim 17, wherein the damping device includes a fluid damper.

19. The drive according to claim 16, wherein the second magnet is a permanent magnet.

20. The drive according to claim 16, further comprising a position detector that determines a position of the drive shaft.

21. The drive according to claim 20, wherein the position detector includes a Hall sensor or a potentiometer.

22. The drive according to claim 20, wherein the position detector includes the second magnet as a position-providing component.

23. The drive according to claim 16, wherein the angle of rotation of the second magnet is limited by means of the angle-of-rotation limiter to α≤180°.

24. The drive according to claim 23, wherein the angle of rotation of the second magnet is limited to α≤120°.

25. The drive according to claim 24, wherein the angle of rotation of the second magnet is limited to 80°≤α≤100°.

26. The drive according to claim 16, wherein the first magnet and the second magnet are arranged on a plate and/or at least partially in a housing, wherein the plate or the housing forms the base.

27. The drive according to claim 17, wherein the second magnet, in the de-energized state of the first magnet, is subject to a holding torque of the damping device.

28. The drive according to claim 16, wherein the second magnet is configured as a plate or a disc.

29. The drive according to claim 16, further comprising an operating device having first operating means for manual actuation and second operating means that interact with the control device to actuate the adjustment component by way of the drive.

30. The drive according to claim 16, wherein the second magnet is configured as an inner rotor, a disc rotor, or an outer rotor relative to a magnetic core.

31. An equipment part comprising a drive according to claim 16.

32. A method for driving an adjustment component of an equipment device for a vehicle with a drive shaft that is rotatable about an axis of rotation in different directions and is configured for connection to an adjusting element of the equipment device, the method comprising the steps of:
providing a first magnet configured as an electromagnet;
arranging a second magnet within range of a magnetic field of the first magnet, wherein the second magnet is mounted rotatably in opposite directions of rotation, and wherein an angle of rotation of the second magnet is limited by a limiter;
connecting the second magnet rotationally to the drive shaft; and
connecting the first magnet to a control device for controlling a current supply and for controlling the polarity of the first magnet, so that the first magnet is polarity-reversed when current is supplied and is switched into a de-energized state.
